(19) United States
(12) Patent Application Publication
(10) Pub. No.: US 2009/0019282 A1
(43) Pub. Date: Jan. 15, 2009

(54) Anonymous authentication method based on an asymmetic cryptographic algorithm

(76) Inventors: David Arditti, Clamart (FR); Olivier Charles, Paris (FR); Sebastien Nguyen Ngoc, Chatillon (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/659,296

(22) PCT Filed: Jul. 20, 2005
(86) PCT No.: PCT/FR2005/001868

§ 371 Date: Feb. 2, 2007

(30) Foreign Application Priority Data
Aug. 3, 2004 (FR) 0408572

(51) Int. Cl. H04L 9/00

(52) U.S. Cl. 713/168

(57) ABSTRACT

A method for authenticating at least one client entity (A) by means of an authentication entity (B) based on a public key encryption (ASYM(PB,R))/decryption (ASYM(SB,R′)) algorithm, implemented on the client entity side and authentication entity side, respectively, including, on the client entity side:
generation of a cryptogram (R′) by encryption of a message (R) containing identification data (idA) of said entity, secret data (KA), and an authentication counter value (CA, CB), guaranteeing that said authentication is not replayed,
sending of the cryptogram to the authentication entity and,
on the authentication entity side:
decryption of said cryptogram,
from a data base (DB) storing, for each client entity capable of being authenticated, a record containing at least the identification data for said client entity, determination of the record of said data base corresponding to the decrypted identification data, and
verification of the correspondence between the decrypted secret data and the secret data of said client entity, obtained from said record.

This invention relates in general to the field of entity authentication in a telecommunications network.

More specifically, it concerns a method for anonymous authentication of at least one client entity by an authentication entity, based on an asymmetric-type cryptographic algorithm, for example, for the purposes of authorising or not authorising the user to access resources when the anonymity of the user who is being authenticated is required.

In this description, the term resources must be taken with a very broad assumption and generally designates any function, application, service, or data set that can be accessed by a user and whose access is determined by a pre-authorisation issued upon completion of an authentication procedure. For non-limiting illustrative purposes, this may involve a service provided by a specialised server, a network access function, or a computer resource such as a data base or a software application available on a server and capable of being shared by several users.

Generally speaking, authentication is a security service carried out by an authentication entity, whose objective consists in verifying the identity of a user, thereby bringing proof of the right of this user to access the resources concerned. An authentication entity commonly designates any equipment, machine or computer system that makes it possible to centralise an authentication process and that can be accessed by users desiring to be authenticated for access to resources via a telecommunications network.

Usually, a user desiring to initiate an authentication process has a client identity enabling them to communicate with the authentication entity. In this description, a client entity designates any system or electronic equipment making it possible to exchange data with the authentication entity.

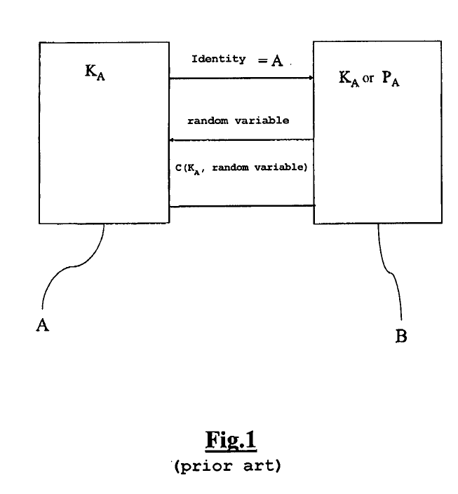

Various authentication techniques exist in the prior art. Among these, strong authentication or “challenge-response” authentication can be cited, which is substantially characterised by the following succession of steps as shown in FIG. 1.

What follows is the description of the case in which a symmetric algorithm is used. When a client entity A desires to be authenticated by an authentication entity B, they first provide their identity to the entity B, in the form of a static identifier that is specific to them, and then proves it by using a secret key K_{A} known and shared by the entities A and B only. In order to accomplish this, when the authentication entity B receives an authentication request submitted by a client entity presenting itself to them as the owner of the identity A, said authentication entity first generates a random number called a random variable, or also called a challenge, and sends this random variable to the client entity A.

In return, the client entity A signs the random variable received according to a predefined secret key cryptographic algorithm, such as the DES algorithm (an acronym for “Data Encryption Standard”). The entity A then returns to the authentication entity B the value C(K_{A}, random variable), where C is the previously cited cryptographic algorithm taking for its operands the K_{A} and random variable values. For its part, the entity B performs the same calculation using the same cryptographic function C and the secret key of A K_{A}, and compares the result obtained with the value that the entity A returned to them. In the case of consistency between the expected result and the value that A returned to them, the authentication entity B validates the authentication, thereby signifying that the entity A has succeeded in being authenticated.

Validation of the authentication, for example, results in the authentication entity granting the client entity A, who has been successfully authenticated, the right to access the requested resources.

Such secret key authentication methods are widespread in telecommunications networks, but nevertheless have a certain number of disadvantages as concerns guaranteeing the anonymity of the client entity desiring to be authenticated. As a matter of fact, in order to initialise the authentication process, a specific identifier for the client identity must be transmitted in clear to the authentication entity. Thus, a malicious third party has it in their power to know the specific identity of the entity that is being authenticated by observing the transaction between the authentication entity and the entity being authenticated.

Furthermore, the specific identifier for an entity desiring to be authenticated can also be deduced by a malicious third party acting this time actively, i.e., by initialising an authentication process by passing themselves off as an authentication entity to the entity being authenticated.

An entity being authenticated can also be recognised by observing its behaviour and, more specifically, by observing the answers provided by the entity during prior authentication processes.

As a matter of fact, the answers provided by a client entity being authenticated are characteristic of certain input data corresponding to the random variables that were submitted to them by the authentication entity and, for the same input data, the authentication entity will always provide the same answer. By observing beforehand the entity's response to characteristic random variable values, it is possible to recognise an entity being authenticated by once again submitting to them these random variable values for which a response by the entity has already been observed, i.e., by making the client entity replay the authentication process for these already furnished values. Thus, an entity who signs random variables in order to be authenticated, can be characterised by their response for a particular random variable value (e.g. 0, 10, 100, 1000, etc. . . . ). By observing two successive identifications with the same random variable, it is therefore possible to deduce if there are two separate entities or the same entity that have been authenticated.

A public key algorithm can also be used in the authentication process as described above with reference to FIG. 1. The entity A then signs the random variable received from the authentication entity B using their private key that they alone possess, and the entity B verifies the accuracy of the calculation in order to ensure that they are indeed in the presence of the entity claiming to be the entity A, by carrying out the reverse operation using the public key A P_{A}, which they possess.

However, this authentication method, based on an asymmetric algorithm, has exactly the same disadvantages as the symmetric version.

The object of this invention is to eliminate the various aforesaid disadvantages by proposing an authentication method using an asymmetric encryption algorithm, in which, in particular, the anonymity of the entity being authenticated is guaranteed, with the result being that only one legitimate authentication entity and no one else is able to recognise the identity of the entity that is being authenticated.

With this purpose in view, the object of the invention is a method for authenticating at least one client entity by means of an authentication entity possessing a private key/public key pair for implementing a public key encryption/decryption algorithm, on the client entity side and authentication entity side, respectively,

said method including, on the client entity side, steps for:
generating a cryptogram obtained by encryption of an authentication message containing identification data specific to said entity, associated secret data, and an authentication counter value, provided for guaranteeing that said authentication is not replayed,
sending the cryptogram thus obtained to the authentication entity and,

on the authentication entity side, steps for:
decryption of said cryptogram received, and
from a data base storing, for each client entity capable of being authenticated, a record for said client entity containing at least the identification data for said client entity, determination of the record of said data base corresponding to the decrypted identification data, and
verification of the correspondence between the decrypted secret data and the secret data of said client entity, obtained from said record.

Preferably, for each client entity capable of being authenticated, the corresponding record from the data base also contains the secret data of said client entity.

According to one alternative, obtaining the secret data of said client entity from said record consists in applying a cryptographic MAC-type function taking as its operand a decryption key stored on the authentication entity side and the identification data from said record.

According to another alternative, for each client entity capable of being authenticated, the corresponding record of the data base also contains an image of the secret data of said client entity, obtained by applying a one-way cryptographic function taking as its operand said secret data of said client entity, the step for verifying the correspondence between the decrypted secret data and the secret data for said client entity, obtained from said record, being replaced by a step consisting in verifying the correspondence of the image of said decrypted secret data calculated from said one-way function with the image of the secret data from said record.

According to a first embodiment, the following steps are implemented, prior to the step carried out on the client entity side for encrypting the authentication message:
sending of the authentication counter value, corresponding to an actual counter value stored on the authentication entity side, from said authentication entity to said client entity,
verification, on the client entity side, that the authentication counter value received is strictly greater than a counter value stored on the client entity side,

wherein the encryption step on the client entity side is followed by an updating of said counter valued stored on the client entity side using said authentication counter value received, said counter valued stored on the authentication entity side being incremented following the verification step implemented on the authentication entity side.

Preferably, the verification step on the authentication entity side further consists in verifying the correspondence between the decrypted authentication counter value and the actual counter value stored on the authentication entity side.

The counter valued stored on the authentication entity side is preferably incremented by a constant value.

According to one alternative, the counter value stored on the authentication entity side is incremented by a random value.

Sending of the authentication counter value from the authentication entity to the client entity is preferably carried out in response to the sending of an anonymous authentication request from said client entity to said authentication entity.

According to a second embodiment, the authentication counter value corresponds to an actual counter value stored on the client entity side, each record from the data base further contains a counter value stored on the authentication entity side, which is specific to the client entity, said method including, on the client entity side, and following the step for decrypting the authentication message:
a step for incrementing said counter value stored on the client entity side,

and, on the authentication entity side:
following the step for determining the record of said data base corresponding to the decrypted identification data, a step for verifying that the decrypted authentication counter value is strictly greater than the counter value of said record specific to the identified client entity, and
following the step for verifying the correspondence between the decrypted secret data and the secret data obtained from said record, a step for updating said counter value of said record specific to the identified client entity with said decrypted authentication counter value.

The counter values advantageously correspond to clock values implemented on the client entity side and on the authentication entity side.

The invention also relates to an integrated circuit including calculation and storage means for implementing the method according to the invention.

The device advantageously includes a contact or contactless smart card.

The invention also relates to an authentication entity for at least one client entity, characterised in that it includes a contact or contactless smart card reader equipped with means for implementing the method according to the invention.

The invention further relates to a program recorded on a data medium and containing instructions for controlling the execution of the method according to the invention via a computer system.

Advantageously, owing to the method according to the invention, only one legitimate authentication entity is able to recognise the identity of the client entity seeking to be authenticated. The identity of the client entity A seeking to be authenticated is known only by the authentication entity B and is never revealed during the authentication process. Furthermore, the client entity A does not know under which name it is identified by the authentication entity. The entity that is authenticated does not in fact have any static identity that could be revealed.

Likewise, use of an authentication counter being synchronized with each authentication on the client entity side and on the authentication entity side ensures, on the one hand, the impossibility for any other entity but the authentication entity to recognise the client entity by observing their behaviour, by seeing to it that a client entity refuses to be authenticated in the presence of a question that has already been submitted to them and, on the other hand, ensures the impossibility of cheating, with respect to the authentication entity, by replaying a previous valid authentication.

Thus, a malicious third party is incapable of differentiating between client entities. When looking at two successive authentications, it is not possible to say if they are two separate entities or the same entity that have been authenticated. Thus, there is complete anonymity.

These advantages, as well as other characteristics and advantages of this invention will become more apparent upon reading the following description given for non-limiting and illustrative purposes and made in reference to the appended figures in which:

FIG. 1 is a diagram showing a secret or public key authentication process according to the prior art, and has already been described;

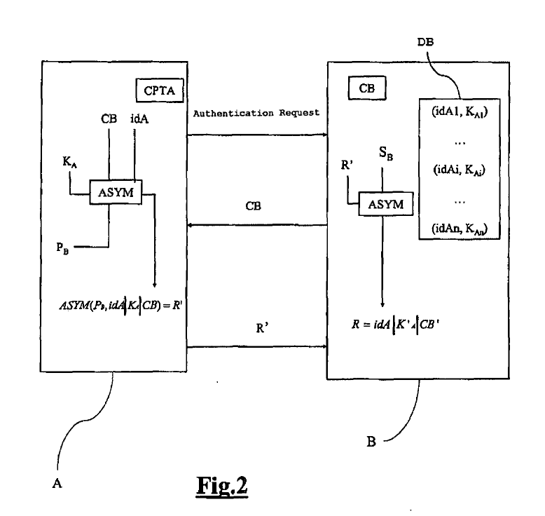

FIG. 2 is a diagram showing the principal steps of the authentication method according to a first embodiment;

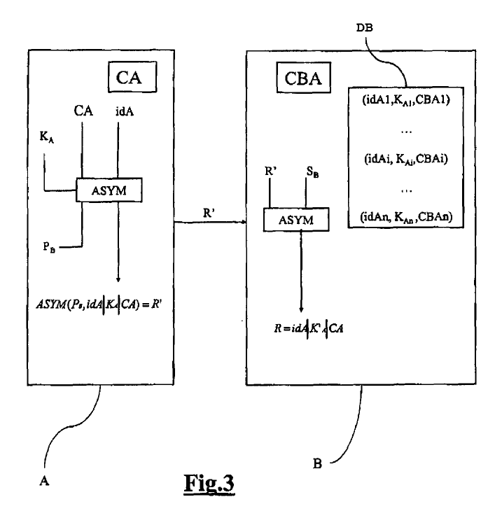

FIG. 3 is a diagram showing the principal steps of the authentication method according to a second embodiment of the invention.

The authentication method according to the invention, guaranteeing the anonymity of the entity being authenticated, is thus based on the use of a public key algorithm. Such an algorithm, referred to as asymmetric, is founded on a pair of complementary keys specific to the authentication entity B: a public key P_{B} and a private key S_{B}. The public key is disclosed and serves as an encryption key, while the private key is known only by its owner, namely the authentication entity B, and serves to decrypt the encrypted message with the public key. The two keys are linked by a one-way function noted as ASYM in the figures, which is specific to each algorithm, where Y=ASYM(P_{B},X) [symbol] X=ASYM(S_{B}, Y).

The entity A that wants to prove its identity contains identification data idA that is specific to it, associated secret data K_{A}, a means for storing a counter value noted as CPTA in FIG. 2 and CA in FIG. 3, the public key P_{B} of the authentication entity B, as well as the public key encryption algorithm noted as ASYM, which is also shared by the authentication entity B, and which is provided so as to be applied with the two following operands: the public key P_{B} and an authentication message needing to be encrypted and that will be described in greater detail below.

As for itself, the authentication entity B, which verifies the identities, contains a data base DB which, for each client entity Ai capable of being authenticated by the authentication entity B, stores a record containing at least the identification data idAi. According to a preferred embodiment, each record of the data base DB further includes the secret data K_{Ai} associated with the client entity Ai. Thus, according to this preferred embodiment, the entity B has the secret data for all the users of the system, which is stored in the data base DB along with the corresponding identification data. It will be seen further on that, according to an alternative, the data base DB may store only the identification data idAi specific to each client entity capable of being authenticated.

The authentication entity B also contains the private key S_{B} corresponding to P_{B} and the public key encryption algorithm ASYM, which is provided so as to be applied with the following two operands: the private key S_{B} and the encrypted message received, so as to recover the message in clear. Finally, the authentication entity B includes means for storing at least one counter value, noted as CB and CBAI, respectively, in FIGS. 2 and 3.

The anonymous authentication process flow according to a first embodiment of the invention is as follows, with reference to FIG. 2. According to this embodiment, the counter value CPTA stored on the client entity side is set to 0 and the authentication counter value CB, on the authentication entity side, is set to 1.

In a first step, when the client entity A wants to be authenticated by the authentication entity B, it is brought to the attention of B via the transmission of an anonymous authentication request, e.g., in the form of the “Authentication Request” message. In response, during a second step, the authentication entity B sends to the client entity A an authentication counter value CB corresponding to the actual counter value stored on the authentication entity side. Nevertheless, the authentication counter value CB could be sent to the client entity A spontaneously, without it being necessary to implement the first step.

In a third step, the client entity A compares the authentication counter value CB received with the counter value CPTA stored by the client entity A. At this stage, two possibilities are offered to the client entity A:

Either CPTA≧CB, and then the client entity A does nothing further, because this situation signifies that an entity is attempting to make the client entity A replay an authentication. Such being the case, according to one characteristic of the invention, in order not to be recognisable by their behaviour, a client entity never carries out an authentication process twice using the same input data. Thus, this situation puts an end to the authentication process and the client entity refuses to respond to the test from the authentication entity.

Or CPTA<CB, and then the client entity A can trust the authentication entity B, because the authentication counter value CB received is strictly greater than the counter value CPTA stored by A, and that signifies that this counter value CB has never before been presented to them. The process then passes on to the next step.

In a fourth step, once the test on CB has guaranteed that the authentication was not replayed, the client entity A encrypts an authentication message R which is specific to them, consisting of the concatenated idA, K_{A} and CB data: R=ida|KA|CB. To do so, the client entity A calculates: R′=ASYM(P_{B},R), and the cryptogram R′ thus obtained is transmitted from the client entity A to the authentication entity B. The client entity A then updates its stored counter value CPTA with the last valid counter value that was transmitted to them by the authentication entity B, namely CB.

In a fifth step, the authentication entity decrypts the cryptogram R′ received and recovers the authentication message in clear R, by applying the encryption algorithm ASYM to the cryptogram R′ using the private key S_{B}: R=ASYM(S_{B},R′). The decrypted message is then noted as R=ida|K′_{A}|CB′, K′_{A} being the decrypted secret data and CB′ being the decrypted authentication counter value.

From the decrypted identification data idA, the entity B determines the corresponding record in its data base DB. The entity B must then verify if the secret data K′_{A} decrypted from the cryptogram received actually corresponds to the secret data K_{A} associated with the client entity A. In order to carry out this verification, the secret data K_{A} of the client entity A is obtained, on the authentication entity side, from the previously determined record.

According to the preferred embodiment, the data base DB is provided for storing the secret data K_{Ai} associated respectively with the identification data idAi of the client entities capable of being authenticated. Thus, the secret data K_{A} associated with the client entity A is stored in the record that was determined from the identification data idA decrypted by B. The entity B can thus find the associated secret data K_{A} using the record corresponding to the decrypted data idA.

The entity B then verifies if the secret data k′_{A} decrypted from the cryptogram received corresponds to the secret data KA identified in the data base, thus K′_{A}=K_{A}.

In the case where the records of the data base on the authentication entity side contain only the identification data idAi of the client entities Ai, the secret data KA associated with the client entity A identified during authentication is then determined dynamically on the authentication entity side. This determination may result from a diversification calculation performed by the authentication entity using the data base record that was determined and that contains the identification data idA of the client entity A. For example, the secret data KA, corresponding to the client entity concerned, is the result of the following diversification calculation: KA=MAC(M,ida), where MAC is a cryptographic MAC using a master encryption key M and operating on the identification data idA. The key M must then be stored on the authentication entity side. The steps of the method remain unchanged except for the previously described verification step K′A=KA, which becomes K′A=MAC(M,ida).

The authentication entity B further verifies whether the decrypted authentication counter value, noted as CB′, does indeed correspond to the actual value CB of its authentication counter, that is to say CB′=CB, so as to ensure that an attacker does not attempt to be authenticated by passing themselves off as A while providing a cryptogram R′ that might have been observed, corresponding to a authentication counter value previously submitted to the client entity during a prior authentication.

If the tests are verified, the client entity A is authenticated, and the authentication entity B increments its stored counter value CB for an upcoming authentication process.

Otherwise, the client entity A is not authenticated.

Preferably, the authentication counter value CB stored on the authentication entity side is incremented by a constant value. However, the fact of increasing the counter value by a constant increment step makes it possible to predict the authentication counter values that will be used during upcoming authentications. For this reason, an attacker can request several values R′ from an entity A for several consecutive counter values CB and subsequently seek to be authenticated by the entity B by returning to them the values previously obtained from the client entity A. Thus, the attacker could become authenticated by passing themselves off as A. Two types of countermeasures against such an attack to the authentication system can be implemented.

First of all, a first countermeasure consists in increasing the counter value CB stored on the authentication entity side by a random value, at each authentication, so as to no longer use successive CB values.

Another countermeasure, on the client entity side, consists in no longer decrypting an authentication message R based on a single counter value CB, but on a pair (CB, random variable), CB being incremented regularly and the random variable assuming random values. Provisions are made for the random value to be different for each of the authentication counter values sent.

The authentication method as just described is vulnerable to attacks by counter skips, based on the fact that the entities A and B are synchronised to the counter value CB at each authentication. Thus a malicious machine can pass itself off as the authentication entity B and send the client entity seeking to be authenticated a much larger counter value than the actual authentication counter value CB, corresponding to the actual counter value stored on the entity B side. By updating its stored counter value CPTA with this large CB value that is submitted to them, the entity A will no longer be able to respond following an authentication request, insofar as the counter value CB of the authentication entity B will not have caught up with this CPTA value, because of the test in the third step. Furthermore, if the malicious machine provides the entity A with a maximum counter value, said entity, by updating its stored counter value CPTA to this maximum value, becomes permanently unusable as a result.

The countermeasures against these attacks more specifically involve the third step of the authentication method, wherein the client entity A compares the counter value CB received with the counter value CPTA stored by the client entity A.

According to one alternative of the invention, in the case where CPTA≧CB, the following intermediate steps are implemented:
the entity A reports to the entity B that its stored counter value CPTA is larger than the value CB and sends back to it CPTA;
the entity B sends a counter value CB_{temporary}>CPTA to the entity A;

then, the other steps of the authentication method are implemented on the basis of this CB_{temporary} value and, if the authentication of the entity A succeeds using CB_{temporary}, then the entity B updates its stored actual authentication counter value CB with the authentication counter value CB_{temporary}. Finally, the authentication counter value CB stored on the entity B side is incremented for an upcoming authentication. This process enables the authentication entity to protect itself against an attack due to counter skips. As a matter of fact, it will first authenticate the client entity A using CB_{temporary}, before updating its stored counter value. This process also enables the client entity to synchronise the counter value of the authentication entity A with its stored counter value, if the latter had undergone an attack due to counter skips.

At this stage, the entity B can also implement additional protective measures. For example, B can authorise only a certain number of these counter synchronisations per client entity and per time period. Likewise, B can authorise these protective measures only within a reasonable limit, wherein the difference between the counter value stored by the client entity CPTA and the authentication counter value CB is less than a predetermined value.

According to one alternative, in the third step of the method, in the case where the relationship CPTA<CB is verified, it is further verified, on the client entity side, if the difference between the authentication counter value CB received and the counter value CPTA stored by the client entity is less than or equal to a predetermined value Δ, that it to say CB−CPTA≦Δ. The entity A agrees to proceed with the authentication only if this additional condition is verified. This additional condition enables the client entity A seeking to be authenticated to limit the attacks due to counter skips by accepting only a moderate incrementation of its stored counter value and by ignoring the prompts using an authentication counter value much higher than its stored value.

A second embodiment of the invention is described, with reference to FIG. 3, for implementing a uni-directional version of the authentication method, i.e., requiring only exchanges in the direction of the client entity towards the authentication entity.

According to this embodiment, individual counters are used, on the authentication entity side, for each client entity. Thus, the data base DB, on the authentication entity side, further includes, for each client entity Ai capable of being authenticated, a stored counter value CBAi specific to each client entity Ai. The data base DB of the authentication entity B thus contains records of the following type, containing at least:

[identification data for the client entity Ai: idAi; counter value for this client entity: CBAi];

Or, according to the preferred embodiment, containing:

[identification data for the client entity Ai: idAi; secret data associated with this client entity: K_{Ai}; counter value for this client entity: CBAi].

Thus, with reference to FIG. 3, the anonymous authentication process flow according to the uni-directional embodiment of the invention is as follows. According to this embodiment, the authentication counter value corresponds to the actual counter value CA stored on the client side. The counter value CA stored on the client side is set to 1 and the counter value, noted as CBA, corresponding to this client entity, and stored on the authentication entity side, is set to 0.

In a first step, the client entity A encrypts an authentication message R that is specific to it, consisting of the concatenated idA, K_{A} and CA data: R=ida|KA|CB. In order to do so, the client entity A calculates: R′=ASYM(P_{B},R), and the cryptogram R′ thus obtained is transmitted from the client entity A to the authentication entity B. The client entity A then increments its stored authentication counter value CB.

In a second step, the authentication entity B decrypts the cryptogram R′ received and recovers the authentication message in clear R, by applying the decryption algorithm ASYM to the cryptogram R′ using the private key S_{B}: R=ASYM(S_{B},R′). The decrypted message is then noted as R=idA|K′_{A}|CA.

From the decrypted identification data idA, the entity B, now knowing the identity of A, determines the corresponding record and recovers from its data base DB the elements K_{A} and CBA associated with the client entity identified.

The entity B then compares the decrypted authentication counter value CA with that CBA associated with the client identity identified in its data base.

Given CA≦CBA, the entity B thus refuses the authentication because it involves a replay. The client entity A is not authenticated and the authentication process ends.

Given CA<CBA, then that signifies that this authentication counter value CA has not yet ever been presented to the authentication entity B and the process passes on to the next step.

The authentication entity B then verifies whether the secret data K′_{A} decrypted from the cryptogram received actually corresponds to the secret data K_{A} associated with the client entity A, which secret data K_{A} is obtained from the data base record, in the same way as explained previously with reference to the bi-directional embodiment of FIG. 2, depending on whether or not the data base record concerned stores the secret data K_{A} associated with idA. Thus, over the course of this step, the entity B verifies if K′_{A}=K_{A} or if K′_{A}=MAC(M,ida).

If the verification is successful, the client entity A is authenticated and the authentication entity B updates the counter value CBA specific to the client entity A, on the authentication entity side, using the last valid authentication counter value CA that was transmitted to it in encrypted form by the client entity A.

Otherwise, the client entity A is not authenticated.

This uni-directional embodiment advantageously makes it possible to prevent the sending of an authentication counter value from the authentication entity B to the client entity A in order to initiate the process. Only encrypted messages travel from the client entity to the authentication entity B. Attacks due to counter skips such as those described in reference to the first embodiment are thereby prevented.

According to one example, the authentication counter values used in the first or the second embodiment can be binary numbers encoded on at least 128 bits.

In the calculation of R=ASYM(P_{B},R) implemented on the client entity side according to the first or the second embodiment, it will be possible, for example, to use the RSA-type asymmetric algorithm, with an encryption exponent having a low value (3, for example). The calculation thus amounts to performing two modulo multiplications, which can be easily carried out in a very short period of time using a smart card without a cryptoprocessor.

The following optimisation can be introduced with regard to the method according to the invention, applying equally to the bi-directional or uni-directional embodiment. Thus, in order to prevent secret data K_{Ai} from being stored directly in the data base DB of the entity B, it is possible to instead store the image of K_{Ai}, noted as U_{Ai}, by applying a one-way cryptographic function U: U_{Ai}=U(K_{Ai}).

The test K′_{A}=K_{A} then becomes U_{A}=U(K′_{A}). For the function U, it is possible to use a hashing function (MD5, SHA . . . ), or else a Sym encryption function based on a symmetric algorithm (DES, AES . . . ), taking as its operand the secret data KA and a constant, such as U(K_{A})=Sym (K_{A}, constant).

Other optimisations can also be introduced, this time applying only to the uni-directional embodiment. The purpose of these optimisations is to carry out a decentralised authentication of the user who will thereby be able to be authenticated by several authentication entities without them having to communicate or share data and, in particular, the authentication counter values CBAi specific to the various client entities Ai stored on the authentication entity side.

In order to do this, one optimisation consists in implementing a clock on the client entity side and authentication entity side, in order to set the authentication counter values CA and CBA on the client entity side and authentication entity side, respectively. Thus, the authentication counter values CA and CBA, for example, can be the time elapsed in seconds as of a specified date. Thus, the authentication counter value CA is replaced by a clock value HA implemented on the client entity side, and the counter value CBA is replaced by a clock value HB implemented on the authentication entity side.

However, it must be taken into account that the clock on the client entity side is liable to lag behind, which is likely to distort the test steps implemented during the second step by the authentication entity, and to lead the authentication entity to consider a valid authentication attempt as an attempt to replay an authentication. It is therefore necessary to provide for a margin of error D corresponding to an upper bound of the offset for all of the clocks implemented on the side of client entities and authentication entities. The test CA>CBA is then replaced by the test HA>HB−D, which authorises the authentication if the clock values on the client entity side and authentication entity side are offset by less than D seconds.

One problem that must be addressed is that an attacker can possibly replay an authentication with a client entity during this time interval of D seconds. Thus, it is necessary to select D to be as small as possible while at the same time remaining compatible with the accuracy of the clocks used.

In the case where the client entity does not have a clock onboard, it is nevertheless possible to implement the above-proposed alternative by using an external clock HA, which will be able to reside outside of the client entity. For example, it may involve the clock of a PC-type computer. In that case, the client entity A retains an internally stored counter value CA whose value corresponds to the last clock value submitted. In order to be authenticated, the client entity A first reads the clock value HA of the PC from the outside and, if the following test is verified: HA>CA, delivers the cryptogram R′=ASYM(P_{B},idA|K_{A}|HA) to the authentication entity and updates CA: CA=HA. This test aims to take protective measures against an attacker that would seek to authenticate A by observing their behaviour while successively submitting to them the same clock values HA.

The steps of the method according to the first or the second embodiment with reference to FIG. 2 or 3, can be implemented, on the client side, on any physical device including an integrated circuit equipped with calculation and storage means. For example, it may involve a contact or contactless smart card. According to this example, the authentication entity is then in the form of a contact or contactless smart carder reader.

In general, the method steps can be in the form of a program, recorded on a data medium and containing instructions for controlling the execution of the method, as just described, via a computer system.

Thus, the program for controlling the execution of the method according to the invention can be recorded in or transmitted by a data medium containing instructions for controlling the execution of the previously described method via a computer system. The data medium can be a storage material medium, e.g., a CD-ROM, a magnetic diskette or a hard disk, or else a transmissible medium such as an electrical, optical or radio signal.

1-15. (canceled)

16. A method for authenticating at least one client entity by means of an authentication entity possessing a private key/public key pair for implementing a public key encryption/decryption algorithm, on the client entity side and authentication entity side, respectively,
said method including, on the client entity side, steps for:
generating a cryptogram obtained by encryption of an authentication message containing identification data specific to said entity, associated secret data, and an authentication counter value, provided for guaranteeing that said authentication is not replayed,
sending the cryptogram thus obtained to the authentication entity and,
on the authentication entity side, including steps for:
decryption of said cryptogram received, and
from a data base storing, for each client entity capable of being authenticated, a record containing at least the identification data for said client entity, determination of the record of said data base corresponding to the decrypted identification data, and
verification of the correspondence between the decrypted secret data and the secret data of said client entity, obtained from said record.

17. A method of claim 16, wherein for each client entity capable of being authenticated, the corresponding record from the data base also contains the secret data of said client entity.

18. A method of claim 16, wherein obtaining the secret data of said client entity from said record consists in applying a cryptographic MAC-type function taking as its operand a decryption key stored on the authentication entity side and the identification data from said record.

19. A method of claim 16, wherein for each client entity capable of being authenticated, the corresponding record of the data base also contains an image of the secret data of said client entity, obtained by applying a one-way cryptographic function taking as its operand said secret data of said client entity, the step for verifying the correspondence between the decrypted secret data and the secret data for said client entity, obtained from said record, being replaced by a step consisting in verifying the correspondence of the image of said decrypted secret data calculated from said one-way function with the image of the secret data from said record.

20. A method as claimed in claim 16, including, prior to the step carried out on the client entity side for encrypting the authentication message, steps for:
sending of the authentication counter value, corresponding to an actual counter value stored on the authentication entity side, from said authentication entity to said client entity,
verification, on the client entity side, that the authentication counter value received is strictly greater than a counter value stored on the client entity side,
wherein the encryption step on the client entity side is followed by an updating of said counter valued stored on the client entity side using said authentication counter value received, said counter valued stored on the authentication entity side being incremented following the verification step implemented on the authentication entity side.

21. A method of claim 20, wherein the verification step on the authentication entity side further consists in verifying the correspondence between the decrypted authentication counter value and the actual counter value stored on the authentication entity side.

22. A method as claimed in claim 20, wherein counter value stored on the authentication entity side is incremented by a constant value.

23. A method as claimed in claim 20, wherein the counter value stored on the authentication entity side is incremented by a random value.

24. A method as claimed in claim 20, wherein sending of the authentication counter value from the authentication entity to the client entity is carried out in response to the sending of an anonymous authentication request (Authentication Request) from said client entity to said authentication entity.

25. A method as claimed in claim 16, wherein the authentication counter value corresponds to an actual counter value stored on the client entity side, each record from the data base further contains a counter value stored on the authentication entity side, which is specific to the client entity, said method including, on the client entity side, and following the step for decrypting the authentication message:
a step for incrementing said counter value stored on the client entity side,
and, on the authentication entity side:
following the step for determining the record of said data base corresponding to the decrypted identification data, a step for verifying that the decrypted authentication counter value is strictly greater than the counter value of said record specific to the identified client entity, and
following the step for verifying the correspondence between the decrypted secret data and the secret data obtained from said record, a step for updating said counter value of said record specific to the identified client entity with said decrypted authentication counter value.

26. A method of claim 25, wherein the counter values correspond to clock values implemented on the client entity side and authentication entity side.

27. A device for authenticating, including an integrated circuit including calculation and storage means for implementing the method according to claim 16 as a client entity.

28. A device of claim 27, including a contact or contactless smart card.

29. Authentication entity for at least one client entity, including a contact or contactless smart card reader equipped with means for implementing the method as claimed in claim 16.

30. A program recorded on a data medium and containing instructions for controlling the execution of the method as claimed in claim 16 via a computer system.
